(19) United States
(12) Patent Application Publication
(10) Pub. No.: US 2017/0126082 A1
(43) Pub. Date: May 4, 2017

(54) ROTATING ELECTRIC MACHINE

(71) Applicant: DENSO CORPORATION, Kariya-city (JP)

(72) Inventor: Shin KUSASE, Kariya-city (JP)

(73) Assignee: DENSO CORPORATION, Kariya-city (JP)

(21) Appl. No.: 15/297,713

(22) Filed: Oct. 19, 2016

(30) Foreign Application Priority Data
Nov. 3, 2015 (JP) 2015-216221

(51) Int. Cl. H02K 1/27; H02K 3/28; H02K 3/12

(52) U.S. Cl. CPC H02K 1/2773; H02K 3/12; H02K 3/28

(57) ABSTRACT

A rotating electric machine includes an armature, a controller and a rotor. The armature includes an armature core and a multi-phase coil. The controller controls energization of the multi-phase coil. The rotor includes magnetic pole portions that are circumferentially spaced from one another, inter-pole permanent magnets each of which is interposed between one circumferentially-adjacent pair of the magnetic pole portions, and a bypass yoke portion located on the opposite radial side of the magnetic pole portions and the inter-pole permanent magnets to the armature. The number of the magnetic pole portions is equal to that of magnetic poles to be created in the armature core upon energization of the multi-phase coil. A plurality of magnetic circuits are formed by the armature core, the magnetic pole portions, the inter-pole permanent magnets and the bypass yoke portion; each of the magnetic circuits passes through one circumferentially-adjacent pair of the magnetic pole portions.

### CROSS-REFERENCE TO RELATED APPLICATION

This application is based on and claims priority from Japanese Patent Application No. 2015-216221 filed on Nov. 3, 2015, the content of which is hereby incorporated by reference in its entirety into this application.

### BACKGROUND

1 Technical Field

The present invention relates to rotating electric machines which include, at least, an armature and a rotor, but no field winding.

2 Description of Related Art

To achieve a small size, high performance, long service life and high reliability, rotating electric machines generally employ a brushless structure with a permanent magnet field. On the other hand, for usage in a wide rotational speed range, it is necessary to vary the field strength. However, with the aforementioned permanent magnet field, it is difficult to vary the field strength; thus losses occur and there are limitations on the characteristics of the rotating electric machines. Therefore, one may consider employing a winding field instead of the permanent magnet field. However, the space required for receiving a winding is generally larger than that required for receiving a permanent magnet. Moreover, a winding is generally required to be wound on a core. Consequently, a considerably large volume is required for employing the winding field. As a result, it is difficult to achieve the original object, i.e., to achieve a small size and high performance.

Japanese Patent Application Publication No. JP2000041367A discloses a hybrid excitation synchronous rotating electric machine developed for reducing the overall size, preventing occurrence of magnetic saturation and making high-speed rotation possible. Specifically, in the hybrid excitation synchronous rotating electric machine, a rotor is disposed radially outside a stator so that a back yoke portion of the rotor faces armature cores of the stator with a radial gap formed therebetween. Moreover, the rotor further has a plurality of N-pole permanent magnets, a plurality of S-pole permanent magnets, a first group of core salient poles and a second group of core salient poles, all of which are provided on a radially inner periphery of the back yoke portion of the rotor. The N-pole permanent magnets are arranged alternately with the core salient poles of the first group in a circumferential direction of the rotor. The S-pole permanent magnets are arranged alternately with the core salient poles of the second group in the circumferential direction of the rotor. Furthermore, each of the N-pole permanent magnets is out of axial alignment with all of the S-pole permanent magnets.

However, the hybrid excitation synchronous rotating electric machine disclosed in the above patent document necessitates an excitation winding in addition to an armature coil. Specifically, in the hybrid excitation synchronous rotating electric machine, the excitation winding is embedded in a back yoke portion of the stator. Accordingly, it is necessary for the back yoke portion of the stator to have a considerably large volume so as to allow the excitation winding to be embedded therein. Consequently, it is difficult to achieve a small size of the hybrid excitation synchronous rotating electric machine. In addition, additional manufacturing time is needed for forming the excitation winding and embedding the excitation winding in the back yoke portion of the stator.

On the other hand, to achieve both a small size and a variable field, one may consider realizing a variable field without employing a field winding. However, in this case, the size of a core which surrounds armature coil ends may become too large.

### SUMMARY

According to exemplary embodiments, there is provided a rotating electric machine which includes an armature, a rotor and a controller. The armature includes an armature core and a multi-phase coil. The armature core has a plurality of slots formed therein. The multi-phase coil is wound on the armature core so as to be received in the slots of the armature core. The rotor is disposed so as to radially face the armature through a first radial gap formed therebetween. The controller controls energization of the multi-phase coil. Further, in the rotating electric machine, the rotor includes a plurality of magnetic pole portions, a plurality of inter-pole permanent magnets and a bypass yoke portion. The magnetic pole portions are spaced from one another in a circumferential direction of the rotor. Each of the inter-pole permanent magnets is interposed between one circumferentially-adjacent pair of the magnetic pole portions. The bypass yoke portion is located on an opposite radial side of the magnetic pole portions and the inter-pole permanent magnets to the armature. Between the bypass yoke portion and the magnetic pole portions and the inter-pole permanent magnets, there is formed a second radial gap. The number of the magnetic pole portions is equal to the number of magnetic poles to be created in the armature core upon energization of the multi-phase coil. The inter-pole permanent magnets are circumferentially magnetized and arranged such that for each circumferentially-adjacent pair of the inter-pole permanent magnets, the magnetization directions of the two inter-pole permanent magnets of the pair are opposite to each other. A plurality of magnetic circuits are formed by the armature core, the magnetic pole portions, the inter-pole permanent magnets and the bypass yoke portion; each of the magnetic circuits passes through one circumferentially-adjacent pair of the magnetic pole portions.

With the above configuration, the magnetic circuits constitute magnetic flux paths that are parallel to the inter-pole permanent magnets and selectively become easy for magnetic flux to pass through. The magnetic flux generated in the armature core upon energization of the multi-phase coil is variable, whereas the magnetic flux generated by the inter-pole permanent magnets is constant. Therefore, it is possible to selectively cause the magnetic fluxes flowing in the magnetic circuits either to flow in the same direction and thus be strengthened by each other or to flow respectively in opposite directions and thus be weakened by each other. Consequently, it becomes possible to realize a variable field without employing a field winding. Moreover, since no field winding is employed, it also becomes possible to minimize the size of the rotating electric machine.

In further implementations, the rotor may further include a magnetic reluctance portion that is provided in the second radial gap so as to rotate together with the magnetic pole portions and the bypass yoke portion; the magnetic reluctance portion is magnetically resistant to the magnetic pole portions.

The magnetic pole portions and the bypass yoke portion may be mechanically connected into one piece either by a plurality of bridge portions of the rotor radially extending to bridge the magnetic pole portions and the bypass yoke portion or by a plurality of fixing members that fix the magnetic pole portions to the bypass yoke portion.

The inter-pole permanent magnets may be arranged in pairs so that each pair of the inter-pole permanent magnets forms a truncated V-shape that opens toward the armature side.

The rotor may have a plurality of recesses each of which is formed in an armature-side peripheral surface of the rotor so as to be located within the truncated V-shape of one pair of the inter-pole permanent magnets.

In the second radial gap, there may be provided a plurality of under-pole permanent magnets so that each of the under-pole permanent magnets is radially aligned with a corresponding one of the magnetic pole portions and located on an opposite radial side of the corresponding magnetic pole portion to the armature.

The controller may control energization of the multi-phase coil to apply magnetomotive force generated in the armature core to the magnetic pole portions of the rotor. The controller may also control a phase angle of the magnetomotive force to be not equal to 0° in electrical angle; the phase angle takes a positive value in a rotational direction of the rotor with an intermediate position between one pair of the magnetic pole portions of the rotor being a reference position.

The plurality of magnetic circuits may include a first magnetic circuit via which magnetic flux flows through the armature core, the circumferentially-adjacent pair of the magnetic pole portions and the bypass yoke portion, and a second magnetic circuit via which magnetic flux flows through the armature core, the circumferentially-adjacent pair of the magnetic pole portions and the inter-pole permanent magnet interposed between the circumferentially-adjacent pair of the magnetic pole portions. The controller may control energization of the multi-phase coil to selectively cause the magnetic flux flowing in the first magnetic circuit and the magnetic flux flowing in the second magnetic circuit to flow either in the same direction or respectively in opposite directions at the circumferentially-adjacent pair of the magnetic pole portions.

### BRIEF DESCRIPTION OF THE DRAWINGS

The present invention will be understood more fully from the detailed description given hereinafter and from the accompanying drawings of exemplary embodiments, which, however, should not be taken to limit the invention to the specific embodiments but are for the purpose of explanation and understanding only.

In the accompanying drawings:

FIG. 1 is a schematic cross-sectional view of a rotating electric machine according to the present invention;

FIG. 2 is a schematic cross-sectional view, taken along the line II-II in FIG. 1, of part of a rotating electric machine according to a first embodiment;

FIG. 3 is a schematic connection diagram illustrating the electrical connection between a controller and a multi-phase coil of the rotating electric machine according to the first embodiment;

FIG. 4 is a schematic view illustrating a first configuration example of magnetic circuits in the rotating electric machine according to the first embodiment;

FIG. 5 is a schematic view illustrating a second configuration example of magnetic circuits in the rotating electric machine according to the first embodiment;

FIG. 6 is a schematic view illustrating a phase angle controlled by the controller;

FIG. 7 is a graphical representation illustrating the relationship between the phase angle and torque of the rotating electric machine according to the first embodiment;

FIG. 8 is a graphical representation illustrating the relationship between the phase angle and torque of a rotating electric machine according to the prior art;

FIG. 9 is a schematic cross-sectional view, taken along the line II-II in FIG. 1, of part of a rotating electric machine according to a second embodiment;

FIG. 10 is a schematic cross-sectional view, taken along the line II-II in FIG. 1, of part of a rotating electric machine according to a third embodiment;

FIG. 11 is a schematic cross-sectional view, taken along the line II-II in FIG. 1, of part of a rotating electric machine according to a fourth embodiment; and

FIG. 12 is a schematic cross-sectional view of part of a rotating electric machine according to a modification of the third embodiment.

### DESCRIPTION OF EMBODIMENTS

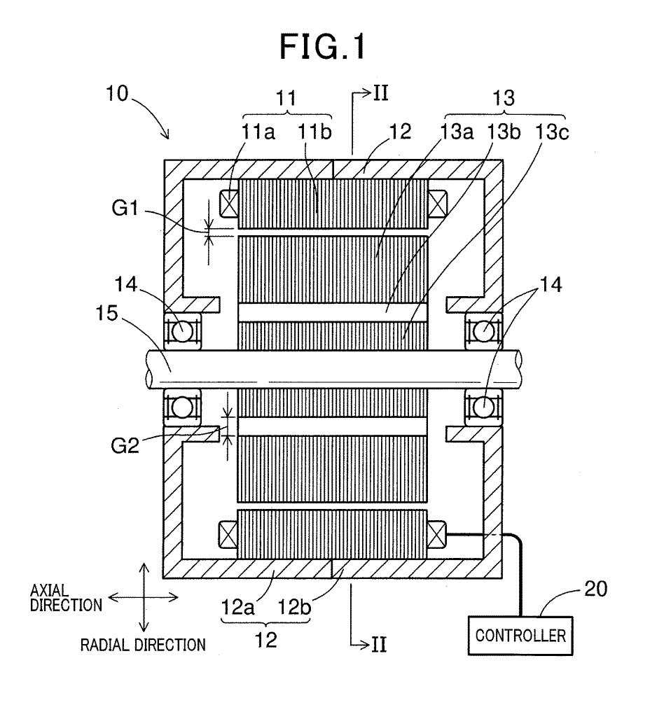

Exemplary embodiments will be described hereinafter with reference to FIGS. 1-12. It should be noted that for the sake of clarity and understanding, identical components having identical functions throughout the whole description have been marked, where possible, with the same reference numerals in each of the figures and that for the sake of avoiding redundancy, descriptions of identical components will not be repeated.

### First Embodiment

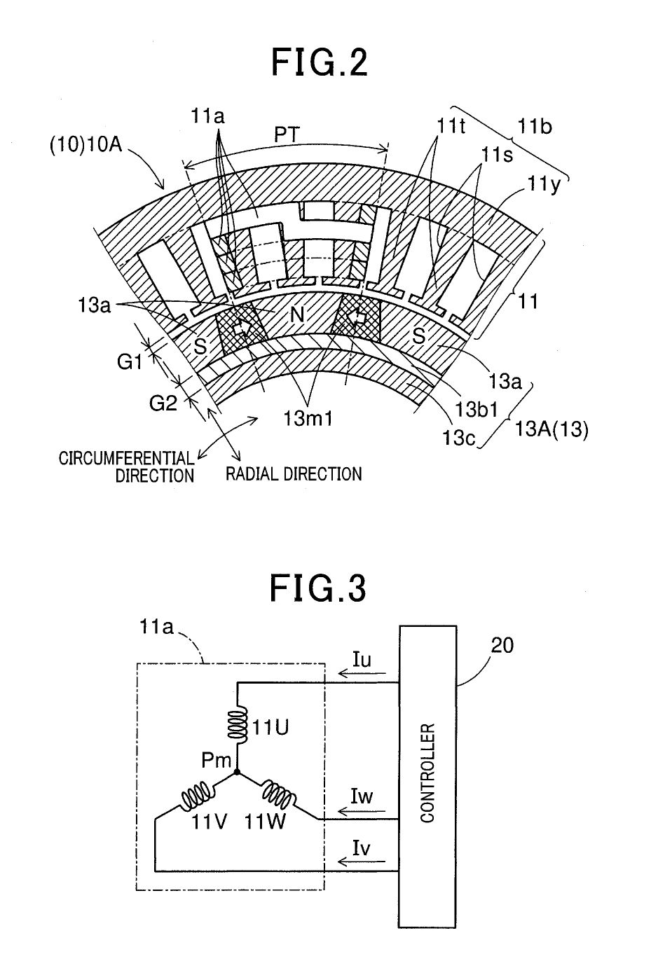

FIG. 1 shows the overall configuration of a rotating electric machine 10 according to the present invention. FIG. 2 shows the configuration of a rotating electric machine 10A according to a first embodiment, which is a first further implementation of the rotating electric machine 10 according to the present invention.

In addition, the rotating electric machine 10 according to the present invention may be an electric motor, an electric generator or a motor-generator that selectively functions either as an electric motor or as an electric generator.

As shown in FIG. 1, the rotating electric machine 10 includes an armature (or stator) 11, a rotor 13, a pair of bearings 14 and a rotating shaft 15, all of which are received in a frame (or housing) 12. Moreover, the rotating electric machine 10 also includes a controller 20 which may be provided either outside or inside the frame 12. For example, in the first embodiment, the controller 20 is provided outside the frame 12. In addition, it should be noted that the rotating electric machine 10 includes no field winding.

The frame 12 may be formed of any suitable material into any suitable shape. The frame 12 supports and fixes thereto, at least, the armature 11. Moreover, the frame 12 rotatably supports the rotating shaft 15 via the pair of bearings 14.

For example, in the first embodiment, the frame 12 is formed of a nonmagnetic material and includes a pair of cup-shaped frame pieces 12a and 12b which are fixed together at the open ends thereof. In addition, the frame pieces 12a and 12b may be fixed together by fixing members (e.g., bolts, nuts or fixing pins) or by welding. It should be appreciated that the frame 12 may also be formed into one piece.

The armature 11 includes a multi-phase coil (or armature coil) 11a and an armature core 11b on which the multi-phase coil 11a is wound.

In the first embodiment, the multi-phase coil 11a is configured as a three-phase coil. The multi-phase coil 11a may be formed of either a single continuous conductor wire or a plurality of conductor wires (or conductor segments) that are electrically connected with each other.

As shown in FIG. 2, the armature core 11b includes a plurality of teeth 11t, a plurality of slots 11s and an annular (hollow cylindrical) back yoke 11y. In the first embodiment, the armature core 11b is formed by laminating a plurality of magnetic steel sheets in an axial direction of the armature core 11b.

The teeth 11t each extend from the back yoke 11y radially inward (i.e., toward the rotor 13) and are spaced from one another at a predetermined pitch in a circumferential direction of the armature core 11b.

Each of the slots 11s is formed between one circumferentially-adjacent pair of the teeth 11t.

The number of the teeth 11t and the number of slots 11s may be set to any suitable numbers. In general, the number of the teeth 11t and the number of slots 11s are equal to each other.

The back yoke 11y is formed, for example, of a soft-magnetic material. In the first embodiment, the back yoke 11y is formed integrally with the teeth 11t into one piece.

The multi-phase coil 11a is wound on the armature core 11b so as to be received in the slots 11s. In addition, the multi-phase coil 11a may be wound in any suitable manner, such as full-pitch winding, short-pitch winding, concentrated winding or distributed winding.

In the first embodiment, as shown in FIG. 2, the multi-phase coil 11a has a substantially rectangular cross-sectional shape and is received in four layers in each of the slots 11s. Moreover, the multi-phase coil 11a extends across a predetermined number of the slots 11s over an angular range corresponding to one magnetic pole pitch PT; in the course of the extension, there is formed a crank-shaped part by which the multi-phase coil 11a is radially offset.

Here, one magnetic pole pitch PT can be determined by the following equation: PT=360°/Pn, where 360° is the mechanical angle of one revolution and Pn is a positive integer representing the number of magnetic poles created in the armature core 11b upon energization of the multi-phase coil 11a.

In addition, the multi-phase coil 11a may have other cross-sectional shapes, such as a circular or triangular cross-sectional shape.

The rotor 13 is disposed radially inside the armature core 11b so as to face a radially inner periphery of the armature core 11b. The rotor 13 is fixed on the rotating shaft 15 so as to rotate together with the rotating shaft 15. In the first embodiment, the rotor 13 is formed by laminating a plurality of magnetic steel sheets in an axial direction of the rotor 13.

The rotor 13 includes a plurality of magnetic pole portions 13a, a magnetic reluctance portion 13b and a bypass yoke portion 13c, but no field winding.

Between the magnetic pole portions 13a and the armature core 11b, there is formed a first radial gap G1. The size of the first radial gap G1 may be set to any suitable value to the extent that magnetic flux can flow between the magnetic pole portions 13a and the armature core 11b.

In the first embodiment, as shown in FIG. 2, the magnetic pole portions 13a are formed of a soft-magnetic material and spaced from one another at predetermined intervals in a circumferential direction of the rotor 13. Between each circumferentially-adjacent pair of the magnetic pole portions 13a, there is interposed one inter-pole permanent magnet 13m1.

The inter-pole permanent magnets 13m1 may have any suitable cross-sectional shape. In the first embodiment, the inter-pole permanent magnets 13m1 have a trapezoidal cross section and are arranged with the shorter side of the trapezoidal cross section facing the armature 11. With this arrangement, the inter-pole permanent magnets 13m1 are prevented from protruding radially outward (i.e., toward the armature 11) during rotation of the rotor 13.

Moreover, as indicated by arrows in FIG. 2, the inter-pole permanent magnets 13m1 are circumferentially magnetized and arranged such that for each circumferentially-adjacent pair of the inter-pole permanent magnets 13m1, the magnetization directions of the two inter-pole permanent magnets 13m1 of the pair are opposite to each other. With this arrangement, the polarities of the magnetic pole portions 13a alternate between N (North) and S (South) in the circumferential direction of the rotor 13.

The number of the magnetic pole portions 13a and the number of the inter-pole permanent magnets 13m1 may be set to any suitable numbers. To increase the total torque of the rotating electric machine 10, it is preferable to set the number of the magnetic pole portions 13a and the number of the inter-pole permanent magnets 13m1 to be equal to the number Pn of the magnetic poles created in the armature core 11b upon energization of the multi-phase coil 11a.

In addition, the magnetic pole portions 13a may also be formed of any other suitable magnetic material. For example, some or all of the magnetic pole portions 13a may be each formed of a permanent magnet instead of the soft-magnetic material.

The magnetic reluctance portion 13b is radially interposed between the magnetic pole portions 13a and the bypass yoke portion 13c. The magnetic reluctance portion 13b has a radial width which corresponds to a second radial gap G2 formed between the magnetic pole portions 13a and the bypass yoke portion 13c. The size of the second radial gap G2 may be set to any suitable value to the extent that magnetic flux can flow between the magnetic pole portions 13a and the bypass yoke portion 13c.

In addition, the magnetic reluctance portion 13b may be provided in any suitable form such that it is magnetically reluctant (or resistant). For example, the magnetic reluctance portion 13b may be provided in the form of an air gap. Alternatively, the magnetic reluctance portion 13b may be formed of a nonmagnetic material or a soft-magnetic material forming only a small magnetic flux path.

The bypass yoke portion 13c is also formed of a soft-magnetic material, similar to the armature core 11b and the magnetic pole portions 13a. The bypass yoke portion 13c is provided to form magnetic circuits through which magnetic flux flows between the magnetite pole portions 13a and the bypass yoke portion 13c or between the armature core 11b and the bypass yoke portion 13c.

As mentioned previously, the rotating electric machine 10A shown in FIG. 2 is the first further implementation of the rotating electric machine 10 according to the present invention. The rotating electric machine 10A includes a rotor 13A which is a first example of the rotor 13 according to the present invention. The rotor 13A includes a nonmagnetic connecting member 13b1 which is a first example of the magnetic reluctance portion 13b according to the present invention.

The nonmagnetic connecting member 13b1 mechanically connects the magnetic pole portions 13a and the bypass yoke portion 13c so as to rotate together with the magnetic pole portions 13a and the bypass yoke portion 13c. The nonmagnetic connecting member 13b1 is formed of a nonmagnetic material so as to be magnetically resistant to the magnetic pole portions 13a. The nonmagnetic material may be a metal material such as copper, stainless steel, aluminum or brass. Alternatively, the nonmagnetic material may be a nonmetal material such as a resin, a fiber-reinforced plastic, a glass fiber or a carbon fiber-reinforced composite material. In addition, the nonmagnetic connecting member 13b1 is formed into an annular (or hollow cylindrical) shape.

In the first embodiment, as shown in FIG. 3, the multi-phase coil 11a is configured as a three-phase coil which includes a U-phase winding 11U, a V-phase winding 11V and a W-phase winding 11W. The U-phase, V-phase and W-phase windings 11U, 11V and 11W are Y-connected to define a neutral point Pm therebetween. In addition, the neutral point Pm may be formed by connecting corresponding ends of the U-phase, V-phase and W-phase windings 11U, 11V and 11W either directly or via an intermediate tap.

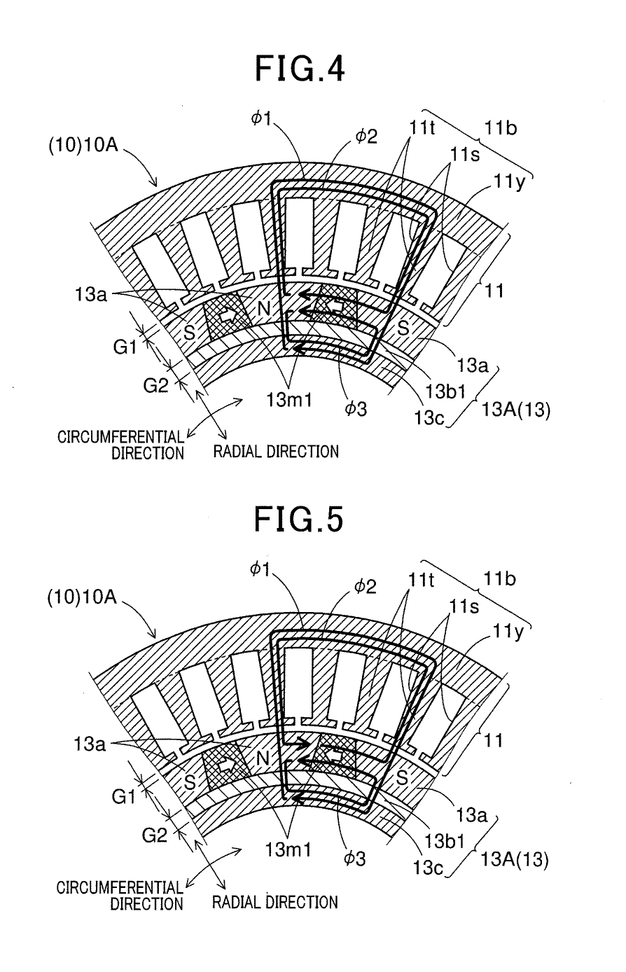

The controller 20 controls three-phase alternating current supplied to the multi-phase coil 11a. More specifically, the controller 20 controls U-phase alternating current Iu supplied to the U-phase winding 11U, V-phase alternating current Iv supplied to the V-phase winding 11V and W-phase alternating current Iw supplied to the W-phase winding 11W. According to the directions of supplying the U-phase, V-phase and W-phase currents Iu, Iv and Iw, the direction of magnetic flux generated in the armature core 11b changes as shown in FIGS. 4 and 5.

FIGS. 4 and 5 show magnetic circuits φ1, φ2 and φ3 which are formed in the rotating electric machine 10A when the three-phase alternating current is supplied to the multi-phase coil 11a. The magnetic circuit φ1 is formed by the armature core 11b, the magnetic pole portions 13a and the bypass yoke portion 13c; in other words, via the magnetic circuit φ1, magnetic flux flows through the armature core 11b, the magnetic pole portions 13a and the bypass yoke portion 13c. The magnetic circuit φ2 is formed by the armature core 11b and the magnetic pole portions 13a; in other words, via the magnetic circuit φ2, magnetic flux flows through the armature core 11b and the magnetic pole portions 13a. The magnetic circuit φ3 is formed by the magnetic pole portions 13a and the bypass yoke portion 13c; in other words, via the magnetic circuit φ3, magnetic flux generated by the inter-pole permanent magnets 13m1 flows through the magnetic pole portions 13a and the bypass yoke portion 13c.

FIG. 4 shows the magnetic fluxes flowing in the magnetic circuits φ1, φ2 and φ3 when electric current is supplied to the multi-phase coil 13a. In this case, the magnetic flux flowing in the magnetic circuit φ1 and the magnetic flux flowing in the magnetic circuit φ2 flow in the same direction and thus are strengthened by (or added to) each other at the magnetic pole portions 13a1 and the inter-pole permanent magnets 13m1. In contrast, the magnetic flux flowing in the magnetic circuit φ1 and the magnetic flux flowing in the magnetic circuit φ3 flow respectively in opposite directions and thus are weakened (or canceled) by each other at the bypass yoke portion 13c.

FIG. 5 shows the magnetic fluxes flowing in the magnetic circuits φ1, φ2 and φ3 when electric current is supplied, in an opposite direction to the case shown in FIG. 4, to the multi-phase coil 13a. In this case, the direction of the magnetic flux flowing in the magnetic circuit φ2 becomes opposite to that in the case shown in FIG. 4. Consequently, the magnetic flux flowing in the magnetic circuit φ1 and the magnetic flux flowing in the magnetic circuit φ2 become to flow respectively in opposite directions and thus be weakened by each other at the magnetic pole portions 13a1 and the inter-pole permanent magnets 13m1.

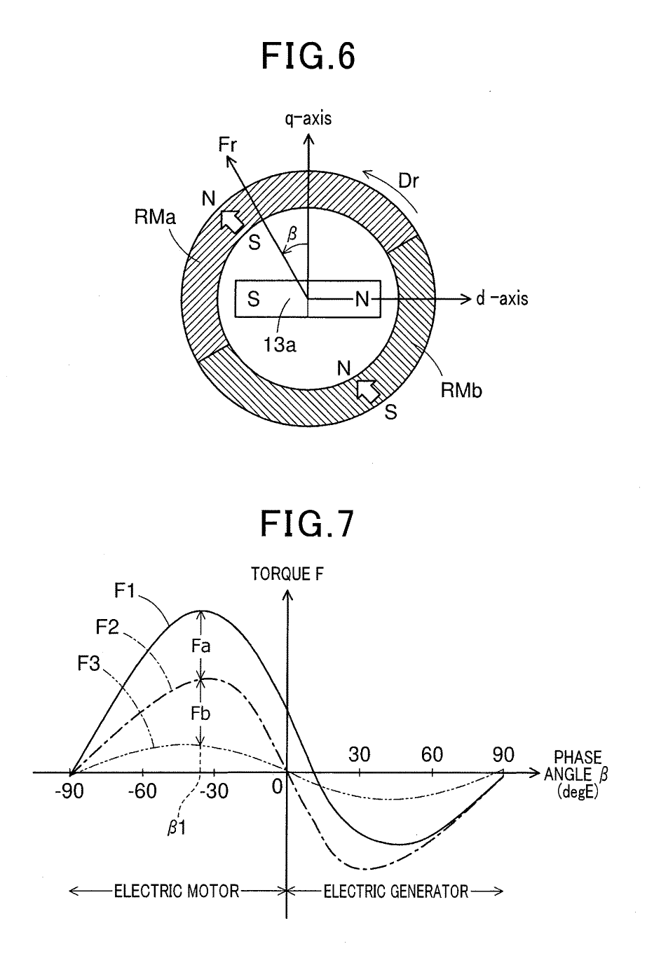

FIG. 6 illustrates a two-pole model that models the relationship between a rotating magnetic field, which is created in the armature core 11b upon supply of the three-phase alternating current to the multi-phase coil 11a, and the magnetic pole portions 13a of the rotor 13A.

In FIG. 6, RMa and RMb designate magnetic poles of the rotating magnetic field created in the armature core 11b. The rotating magnetic poles RMa and RMb are respectively magnetized into polarities (i.e., N and S poles) as indicated by arrows in FIG. 6. Moreover, the rotating magnetic poles RMa and RMb rotate in, for example, a rotational direction Dr indicated by an arrow in FIG. 6. The rotating magnetomotive force of the rotating magnetic poles RMa and RMb corresponds to an “armature magnetomotive force” and is designated as a vector by Fr in FIG. 6. In addition, a d-axis (pole center) and a q-axis (pole boundary) of one magnetic pole portion 13a of the rotor 13A are also indicated by arrows in FIG. 6.

A “phase angle” β is an electrical angle between the rotating magnetomotive force Fr and the magnetic pole portions 13a of the rotor 13A. In FIG. 6, the phase angle β is represented by an angle between the boundary (or intermediate) position between one pair of the magnetic pole portions 13a (i.e., the q-axis) and the rotating magnetomotive force Fr; the phase angle β takes a positive value in the rotational direction Dr with the boundary position being a reference position. In other words, the phase angle β is equal to 0 when the direction of the rotating magnetomotive force Fr coincides with the q-axis.

In addition, though FIG. 6 illustrates an example where the rotational direction Dr coincides with the counterclockwise direction, the following explanation can also be applied to an example where the rotational direction Dr coincides with the clockwise direction. Therefore, no example where the rotational direction Dr coincides with the clockwise direction is shown in the figures. Moreover, when the rotational direction Dr coincides with the clockwise direction, the phase angle β takes a positive value in the clockwise direction. Furthermore, though FIG. 6 illustrates a two-pole model, the following explanation can also be applied to models of four or more poles.

The torque F generated by each magnetic pole portion 13a is equal to the quotient of the torque T, which is generated by all the magnetic pole portions 13a, divided by the number Pn of the magnetic poles. The phase current Ia is electric current per phase of the multi-phase coil 11a and corresponds to any one of the U-phase, V-phase and W-phase currents Iu, Iv and Iw. Let Ψa be flux linkage per phase, Ψec be flux linkage through the magnetic circuit φ1 per phase, and Ψem be flux linkage through the magnetic circuit φ2 per phase. The suffix “a” added to the phase current Ia and the flux linkage Ψa represents each phase, i.e., any one of the U, V and W phases in the first embodiment. Moreover, let Lf be the inductance of the multi-phase coil 11a, Ld be the d-axis inductance, and Lq be the q-axis inductance. Then, the torque F can be determined by the following equation (d) which is obtained by substituting the following equations (b) and (c) into the following equation (a).

$$\begin{matrix}F = \frac{T}{{P}_{n}} = {Ψ}_{a} {I}_{a} cos β + \frac{1}{2} ( {L}_{q} - {L}_{d} ) {I}_{a}^{2} sin 2 β & ( a ) \\ {Ψ}_{a} = ( {Ψ}_{em} + {Ψ}_{ec} ) \sqrt{3} = ( {Ψ}_{em} - {L}_{f} {I}_{a} sin β ) \sqrt{3} & ( b ) \\ {Ψ}_{ec} = - {L}_{f} {I}_{a} sin β & ( c ) \\ F = \frac{T}{{P}_{n}} = \underbrace{\sqrt{3} {Ψ}_{em} {I}_{a} cos β}_{Tm} - \underbrace{\frac{1}{2} {L}_{f} {I}_{a}^{2} sin 2 β}_{Tbyc} + \underbrace{\frac{1}{2} ( {L}_{q} - {L}_{d} ) {I}_{a}^{2} sin 2 β}_{Tr} & ( d )\end{matrix}$$

The right side of the equation (d) includes magnet torque Tm, bypass yoke torque Tbyc and reluctance torque Tr. The magnet torque Tm is torque which is produced by the magnetic flux generated by the inter-pole permanent magnets 13m1. The bypass yoke torque Tbyc is torque which is produced by the magnetic flux flowing through the bypass yoke portion 13c. The reluctance torque Tr is torque which is produced by the magnetic flux flowing through the magnetic pole portions 13a.

FIG. 7 shows the relationship between the above-described phase angle β and torque F. More specifically, in FIG. 7, a characteristic line F1, which is drawn as a continuous line, represents the relationship between the phase angle β and the torque F of the rotating electric machine 10A according to the first embodiment. A characteristic line F2, which is drawn as a one-dot chain line, represents the relationship between the phase angle β and the torque F of the rotating electric machine 10A from which the inter-pole permanent magnets 13m1 are removed. A characteristic line F3, which is drawn as a two-dot chain line, represents the relationship between the phase angle β and the reluctance torque component of the torque F of the rotating electric machine 10A from which the inter-pole permanent magnets 13m1 are removed. Here, the reluctance torque component corresponds to the reluctance torque Tr in the equation (d). In addition, [degE] in FIG. 7 denotes “degrees in electrical angle”.

As shown in FIG. 7, at a value β1 of the phase angle β, there are a torque difference Fa between the characteristic lines F1 and F2 and a torque difference Fb between the characteristic lines F2 and F3. The torque difference Fa is caused by the magnet torque that is produced by the inter-pole permanent magnets 13m1, and corresponds to the magnet torque Tm in the equation (d). The torque difference Fb is caused by the magnetic fluxes that flow through the bypass yoke portion 13c via the magnetic circuits φ1 and φ3, and corresponds to the bypass yoke torque Tbyc in the equation (d). Therefore, the characteristic line F1 is a characteristic line which is obtained by synthesizing the characteristic lines F2 and F3.

In the first embodiment, the controller 20 controls the phase angle β according to the operating mode of the rotating electric machine 10A. More specifically, as shown in FIG. 7, when the phase angle β is controlled by the controller 20 so as to be in the range of −90°<β<0°, the rotating electric machine 10A functions as an electric motor. In contrast, when the phase angle ft is controlled by the controller 20 so as to be in the range of 0°<β<90°, the rotating electric machine 10A functions as an electric generator.

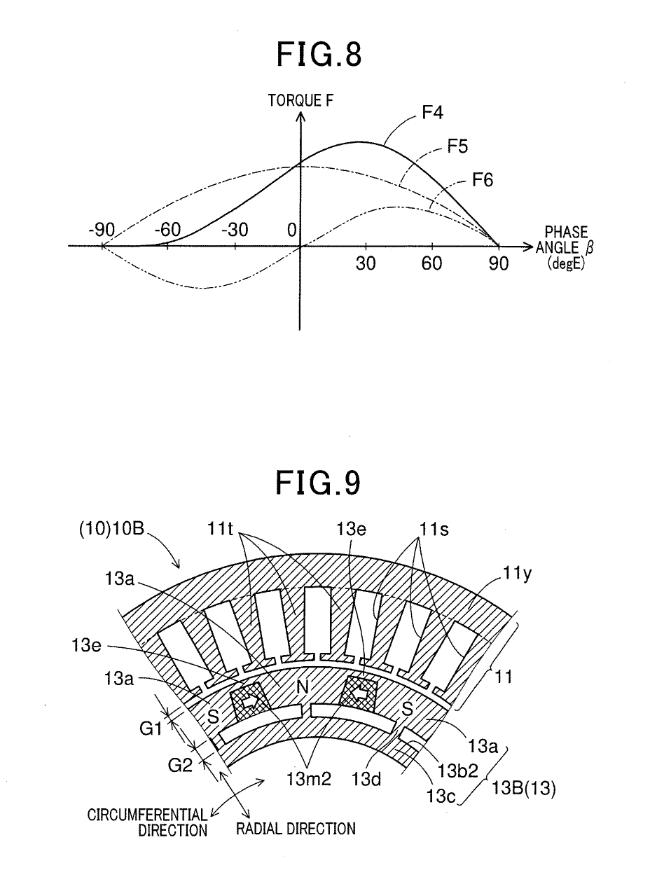

FIG. 8 shows the relationship between the phase angle β and torque F in a conventional rotating electric machine. More specifically, in FIG. 8, a characteristic line F4, which is drawn as a continuous line, represents the total torque characteristics of the conventional rotating electric machine. A characteristic line F5, which is drawn as a one-dot chain line, represents the magnet torque characteristics of the conventional rotating electric machine. A characteristic line F6, which is drawn as a two-dot chain line, represents the reluctance torque characteristics of the conventional rotating electric machine. The characteristic line F6 corresponds to the characteristic line F3 in FIG. 7. As seen from FIG. 8, the conventional rotating electric machine can function as an electric motor, but cannot function as an electric generator.

According to the first embodiment, it is possible to achieve the following advantageous effects.

In the first embodiment, the rotating electric machine 10A includes the armature 11, the rotor 13A and the controller 20. The armature 11 includes the armature core 11b and the multi-phase coil 11a. The armature core 11b has the slots 11s formed therein. The multi-phase coil 11a is wound on the armature core 11b so as to be received in the slots 11s of the armature core 11b. The rotor 13A is rotatably disposed radially inside the armature 11 so as to radially face the armature 11 through the first radial gap G1 formed therebetween. The controller 20 controls energization of the multi-phase coil 11a (i.e., supply of the three-phase alternating current to the multi-phase coil 11a). Further, in the first embodiment, the rotor 13A includes the magnetic pole portions 13a, the inter-pole permanent magnets 13m1 and the bypass yoke portion 13c. The magnetic pole portions 13a are spaced from one another in the circumferential direction of the rotor 13A. Each of the inter-pole permanent magnets 13m1 is arranged between one circumferentially-adjacent pair of the magnetic pole portions 13a. The bypass yoke portion 13c is located on the opposite radial side of the magnetic pole portions 13a and the inter-pole permanent magnets 13m1 to the armature 11. Between the bypass yoke portion 13c and the magnetic pole portions 13a and the inter-pole permanent magnets 13m1, there is formed the second radial gap G2. The number of the magnetic pole portions 13a is equal to the number Pn of the magnetic poles to be created in the armature core 11b upon energization of the multi-phase coil 11a. The inter-pole permanent magnets 13m1 are circumferentially magnetized and arranged such that for each circumferentially-adjacent pair of the inter-pole permanent magnets 13m1, the magnetization directions of the two inter-pole permanent magnets 13m1 of the pair are opposite to each other. The magnetic circuits φ1, φ2 and φ3 are formed by the armature core 11b, the magnetic pole portions 13a, the inter-pole permanent magnets 13m1 and the bypass yoke portion 13c. Each of the magnetic circuits φ1, φ2 and φ3 passes through one circumferentially-adjacent pair of the magnetic pole portions 13a.

With the above configuration, the magnetic circuits φ1, φ2 and φ3 constitute magnetic flux paths that are parallel to the inter-pole permanent magnets 13m1 and selectively become easy for magnetic flux to pass through. The magnetic flux generated in the armature core 11b upon energization of the multi-phase coil 11a is variable, whereas the magnetic flux generated by the inter-pole permanent magnets 13m1 is constant. Therefore, it is possible to selectively cause the magnetic fluxes flowing in the magnetic circuits φ1, φ2 and φ3 either to flow in the same direction and thus be strengthened by each other or to flow respectively in opposite directions and thus be weakened by each other. Consequently, it becomes possible to realize a variable field without employing a field winding. Moreover, since no field winding is employed, it also becomes possible to minimize the size of the rotating electric machine 10A.

In the first embodiment, the rotor 13A further includes the magnetic reluctance portion 13b that is provided in the second radial gap G2 so as to rotate together with the magnetic pole portions 13a and the bypass yoke portion 13c. The magnetic reluctance portion 13b is magnetically resistant to the magnetic pole portions 13a. More particularly, in the first embodiment, the magnetic reluctance portion 13b is implemented by the nonmagnetic connecting member 13b1 that is formed of a nonmagnetic material and mechanically connects the magnetic pole portions 13a and the bypass yoke portion 13c.

With the above configuration, since the magnetic reluctance portion 13b is magnetically resistant to the magnetic pole portions 13a, it is possible to eliminate eddy current, thereby reducing the loss.

In the first embodiment, the controller 20 controls energization of the multi-phase coil 11a to apply the magnetomotive force Fr generated in the armature core 11b to the magnetic pole portions 13a of the rotor 13A. More specifically, the controller 20 controls the energization of the multi-phase coil 11a so as to have the phase angle β of the magnetomotive force Fr not equal to 0° in electrical angle; the phase angle β takes a positive value in the rotational direction Dr of the rotor 13A with the boundary (or intermediate) position between one pair of the magnetic pole portions 13a of the rotor 13A being the reference position.

With the above configuration, it is possible to reliably realize a variable field by varying the phase angle β (or the phase angle of the three-phase alternating current supplied to the multi-phase coil 11a).

In the first embodiment, the magnetic circuits formed in the rotating electric machine 10A include: the magnetic circuit φ1 via which magnetic flux flows through the armature core 11b, the circumferentially-adjacent pair of the magnetic pole portions 13a and the bypass yoke portion 13c; and the magnetic circuit φ2 via which magnetic flux flows through the armature core 11b, the circumferentially-adjacent pair of the magnetic pole portions 13a and the inter-pole permanent magnet 13m1 interposed between the circumferentially-adjacent pair of the magnetic pole portions 13a. The controller 20 controls energization of the multi-phase coil 11a to selectively cause the magnetic flux flowing in the magnetic circuit φ1 and the magnetic flux flowing in the magnetic circuit φ2 to flow either in the same direction or respectively in opposite directions at the circumferentially-adjacent pair of the magnetic pole portions 13a.

With the above configuration, when the magnetic flux flowing in the magnetic circuit φ1 and the magnetic flux flowing in the magnetic circuit φ2 flow in the same direction at the circumferentially-adjacent pair of the magnetic pole portions 13a, they are strengthened by each other (see FIG. 4). In contrast, when the magnetic flux flowing in the magnetic circuit φ1 and the magnetic flux flowing in the magnetic circuit φ2 flow respectively in opposite directions at the circumferentially-adjacent pair of the magnetic pole portions 13a, they are weakened by each other (see FIG. 5). Consequently, it is possible to enhance or weaken the strength of the variable field as needed.

### Second Embodiment

FIG. 9 shows the configuration of a rotating electric machine 10B according to a second embodiment.

The rotating electric machine 10B, which is a second further implementation of the rotating electric machine 10 according to the present invention, has almost the same structure as the rotating electric machine 10A according to the first embodiment. Therefore, the differences of the rotating electric machine 10B from the rotating electric machine 10A will be mainly described hereinafter. In addition, for the sake of simplicity, depiction of a multi-phase coil 11a is omitted from FIG. 9.

In the second embodiment, the rotating electric machine 10B includes a rotor 13B which is a second example of the rotor 13 according to the present invention. The rotor 13B includes a plurality of magnetic pole portions 13a, a plurality of inter-pole permanent magnet 13m2, a plurality of connecting portions 13e, a plurality of voids (or air gaps) 13b2, a bypass yoke portion 13c and a plurality of bridge portions 13d.

The magnetic pole portions 13a are spaced from one another at predetermined intervals in a circumferential direction of the rotor 13B.

Each of the inter-pole permanent magnets 13m2 is interposed between one circumferentially-adjacent pair of the magnetic pole portions 13a. The inter-pole permanent magnets 13m2 have a trapezoidal cross section and are arranged with the shorter side of the trapezoidal cross section located on the armature 11 side (i.e., radially outside). In addition, the inter-pole permanent magnets 13m2 are magnetized and arranged in the same manner as the inter-pole permanent magnets 13m1 described in the first embodiment.

Each of the connecting portions 13e is located on the armature 11 side of one of the inter-pole permanent magnets 13m2 to connect one circumferentially-adjacent pair of the magnetic pole portions 13a. In addition, the radial width of the connecting portions 13e may be suitably set taking into account the connection strength and prevention of magnetic leakage.

The voids 13b2 together constitute a second example of the magnetic reluctance portion 13b according to the present invention. The voids 13b2 are radially interposed between the magnetic pole portions 13a and the inter-pole permanent magnets 13m2 and the bypass yoke portion 13c. The voids 13b2 are spaced from one another at predetermined intervals in the circumferential direction of the rotor 13B.

Each of the bridge portions 13d is formed between one circumferentially-adjacent pair of the voids 13b2 and radially extends to bridge (or mechanically connects) one of the magnetic pole portions 13a and the bypass yoke portion 13c. Consequently, all of the magnetic pole portions 13a, the bridge portions 13d and the bypass yoke portion 13c can rotate together with each other. In addition, the circumferential width of the bridge portions 13d may be suitably set taking into account the bridging strength (or connection strength) and prevention of magnetic leakage.

In the second embodiment, the magnetic pole portions 13a, the connecting portions 13e, the bypass yoke portion 13c and the bridge portions 13d are integrally formed into one piece by laminating a plurality of magnetic steel sheets in an axial direction of the rotor 13B.

Moreover, though not shown in the figures, in the second embodiment, the controller 20 controls energization of the multi-phase coil 11a as described in the first embodiment. Consequently, magnetic circuits φ1, φ2 and φ3 are formed in the rotating electric machine 10B as shown in FIGS. 4 and 5; rotating magnetomotive force Fr is generated as shown in FIG. 6; and torque F is produced as indicted by the characteristic line F1 in FIG. 7.

According to the second embodiment, it is possible to achieve the same advantageous effects as described in the first embodiment.

Moreover, in the second embodiment, the magnetic pole portions 13a and the bypass yoke portion 13c are mechanically connected into one piece by the bridge portions 13d each radially extending to bridge one of the magnetic pole portions 13a and the bypass yoke portion 13c.

With the above configuration, it is possible to enhance the strength of the rotor 13B against the centrifugal force during rotation while simplifying the structure of the rotor 13B.

### Third Embodiment

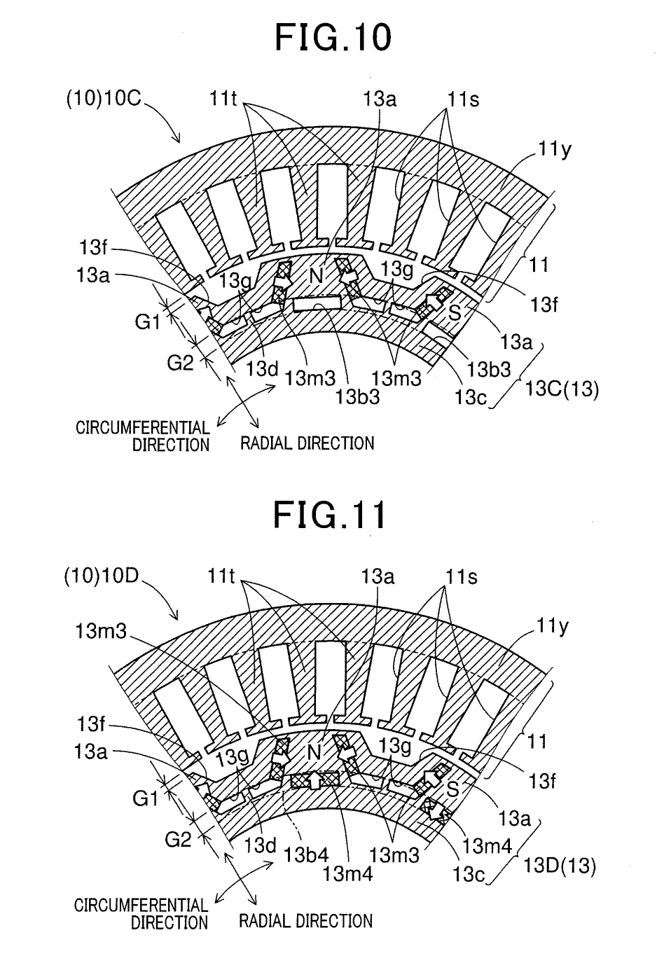

FIG. 10 shows the configuration of a rotating electric machine 10C according to a third embodiment.

The rotating electric machine 10C, which is a third further implementation of the rotating electric machine 10 according to the present invention, has almost the same structure as the rotating electric machines 10A and 10B according to the first and second embodiments. Therefore, the differences of the rotating electric machine 10C from the rotating electric machines 10A and 10B will be mainly described hereinafter. In addition, for the sake of simplicity, depiction of a multi-phase coil 11a is omitted from FIG. 10.

In the third embodiment, the rotating electric machine 10C includes a rotor 13C which is a third example of the rotor 13 according to the present invention. The rotor 13C includes a plurality of magnetic pole portions 13a, a plurality of pairs of inter-pole permanent magnets 13m3, a plurality of recesses 13f, a plurality of magnet-receiving holes 13g, a plurality of voids (or air gaps) 13b3, a bypass yoke portion 13c and a plurality of bridge portions 13d.

The magnetic pole portions 13a are spaced from one another at predetermined intervals in a circumferential direction of the rotor 13B.

Each of the recesses 13f is formed in an armature 11-side peripheral surface (i.e., radially outer surface) of the rotor 13C so as to be located between one circumferentially-adjacent pair of the magnetic pole portions 13a. With the recesses 13f, it is possible to suppress magnetic flux from flowing and thus leaking between circumferentially-adjacent pairs of the magnetic pole portions 13a. Moreover, with the recesses 13f, the magnetic pole portions 13a can function as salient poles. Therefore, the rotating electric machine 10C can function as a synchronous electric motor when operating in a motor mode.

Each of the magnet-receiving holes 13g is formed between one circumferentially-adjacent pair of the magnetic pole portions 13a so as to be located on the non-armature 11 side (i.e., radially inside) of the recess 13f formed between the circumferentially-adjacent pair of the magnetic pole portions 13a. Each of the magnet-receiving holes 13g has a substantially U-shape that opens toward the armature 11 side (i.e., radially outward). Accordingly, each of the magnet-receiving holes 13g has a pair of side portions and a bottom portion between the side portions.

Each pair of the inter-pole permanent magnets 13m3 is received in one of the magnet-receiving holes 13g so that the two inter-pole permanent magnets 13m3 of the pair are respectively arranged in the side portions of the substantially U-shaped magnet-receiving hole 13g. That is, each pair of the inter-pole permanent magnets 13m3 is arranged in a truncated V-shape that opens toward the armature 11 side. In addition, each pair of the inter-pole permanent magnets 13m3 is magnetized in the same manner as one of the inter-pole permanent magnets 13m1 described in the first embodiment.

Each of the voids 13b3 is formed between one circumferentially-adjacent pair of the magnet-receiving holes 13g. The voids 13b3 and the bottom portions of the substantially U-shaped magnet-receiving holes 13g (i.e., those portions of the magnet-receiving holes 13g which are not occupied by the inter-pole permanent magnets 13m3) together constitute a third example of the magnetic reluctance portion 13b according to the present invention.

Between one circumferentially-adjacent pair of the magnet-receiving holes 13g and the voids 13b3, there is formed one of the bridge portions 13d. Moreover, at the circumferential center position of each of the magnet-receiving holes 13g, there is formed one of the bridge portions 13d. Each of the bridge portions 13d radially extends to bridge (or mechanically connects) the bypass yoke portion 13c and one of the magnetic pole portions 13a or the bypass yoke portion 13c and one of intermediate portions between the magnetic pole portions 13a. Consequently, all of the magnetic pole portions 13a, the bridge portions 13d and the bypass yoke portion 13c can rotate together with each other. In addition, the magnetic pole portions 13a, the bridge portions 13d and the bypass yoke portion 13c are integrally formed into one piece by laminating a plurality of magnetic steel sheets in an axial direction of the rotor 13C.

Moreover, though not shown in the figures, in the third embodiment, the controller 20 controls energization of the multi-phase coil 11a as described in the first embodiment. Consequently, magnetic circuits φ1, φ2 and φ3 are formed in the rotating electric machine 10C as shown in FIGS. 4 and 5; rotating magnetomotive force Fr is generated as shown in FIG. 6; and torque F is produced as indicted by the characteristic line F1 in FIG. 7.

According to the third embodiment, it is possible to achieve the same advantageous effects as described in the first and second embodiments.

Moreover, in the third embodiment, the inter-pole permanent magnets 13m3 are arranged in pairs so that each pair of the inter-pole permanent magnets 13m3 forms the truncated V-shape that opens toward the armature 11 side.

With the above arrangement, it is possible to improve the torque characteristics of the rotating electric machine 10C.

Furthermore, in the third embodiment, the rotor 13C has the recesses 13f each of which is formed in the armature 11-side peripheral surface of the rotor 13C so as to be located within the truncated V-shape of one pair of the inter-pole permanent magnets 13m3.

With the above configuration, the recesses 13f constitute auxiliary magnetic poles with respect to the magnetic pole portions 13a. Moreover, the radial gap between the armature 11 and the rotor 13C are increased at the recesses 13f. Consequently, with the recesses 13f, it is possible to reduce leakage magnetic flux and produce additional reluctance torque. As a result, it is possible to increase the total torque F of the rotating electric machine 10C.

### Fourth Embodiment

FIG. 11 shows the configuration of a rotating electric machine 10D according to a fourth embodiment.

The rotating electric machine 10D, which is a fourth further implementation of the rotating electric machine 10 according to the present invention, has almost the same structure as the rotating electric machines 10A-10C according to the first to the third embodiments. Therefore, the differences of the rotating electric machine 10D from the rotating electric machines 10A-10C will be mainly described hereinafter. In addition, for the sake of simplicity, depiction of a multi-phase coil 11a is omitted from FIG. 11.

In the fourth embodiment, the rotating electric machine 10D includes a rotor 13D which is a fourth example of the rotor 13 according to the present invention. The rotor 13D includes a plurality of magnetic pole portions 13a, a plurality of pairs of inter-pole permanent magnets 13m3, a plurality of recesses 13f, a plurality of first magnet-receiving holes 13g, a plurality of second magnet-receiving holes 13b4, a plurality of under-pole permanent magnets 13m4, a bypass yoke portion 13c and a plurality of bridge portions 13d.

The magnetic pole portions 13a are spaced from one another at predetermined intervals in a circumferential direction of the rotor 13D.

Each of the recesses 13f is formed in an armature 11-side peripheral surface (i.e., radially outer surface) of the rotor 13C so as to be located between one circumferentially-adjacent pair of the magnetic pole portions 13a.

Each of the first magnet-receiving holes 13g is formed between one circumferentially-adjacent pair of the magnetic pole portions 13a so as to be located on the non-armature 11 side (i.e., radially inside) of the recess 13f formed between the circumferentially-adjacent pair of the magnetic pole portions 13a. Each of the first magnet-receiving holes 13g has a substantially U-shape that opens toward the armature 11 side (i.e., radially outward). Accordingly, each of the first magnet-receiving holes 13g has a pair of side portions and a bottom portion between the side portions.

Each pair of the inter-pole permanent magnets 13m3 is received in one of the first magnet-receiving holes 13g so that the two inter-pole permanent magnets 13m3 of the pair are respectively arranged in the side portions of the substantially U-shaped first magnet-receiving hole 13g. That is, each pair of the inter-pole permanent magnets 13m3 is arranged in a truncated V-shape that opens toward the armature 11 side. In addition, each pair of the inter-pole permanent magnets 13m3 is magnetized in the same manner as one of the inter-pole permanent magnets 13m1 described in the first embodiment.

Each of the second magnet-receiving holes 13b4 is formed between one circumferentially-adjacent pair of the first magnet-receiving holes 13g so as to be located on the non-armature 11 side (i.e., radially inside) of one of the magnetic pole portions 13a.

Each of the under-pole permanent magnets 13m4 is received in one of the second magnet-receiving holes 13b4 so as to be located under (i.e., radially inside) one of the magnetic pole portions 13a. That is, the under-pole permanent magnets 13m4 are arranged in the second radial gap G2 between the magnetic pole portions 13a and the bypass yoke portion 13c. As indicated by arrows in FIG. 11, the under-pole permanent magnets 13m4 are radially magnetized according to the polarities of the magnetic pole portions 13a. Consequently, for each circumferentially-adjacent pair of the under-pole permanent magnets 13m4, the magnetization directions of the two under-pole permanent magnets 13m4 of the pair are opposite to each other.

In the fourth embodiment, the bottom portions of the substantially U-shaped first magnet-receiving holes 13g (i.e., those portions of the first magnet-receiving holes 13g which are not occupied by the inter-pole permanent magnets 13m3) together constitute a fourth example of the magnetic reluctance portion 13b according to the present invention.

Moreover, at the circumferential center position of each of the first magnet-receiving holes 13g, there is formed one of the bridge portions 13d. Each of the bridge portions 13d radially extends to bridge (or mechanically connects) the bypass yoke portion 13c and one of intermediate portions between the magnetic pole portions 13a. Consequently, all of the magnetic pole portions 13a, the bridge portions 13d and the bypass yoke portion 13c can rotate together with each other. In addition, the magnetic pole portions 13a, the bridge portions 13d and the bypass yoke portion 13c are integrally formed into one piece by laminating a plurality of magnetic steel sheets in an axial direction of the rotor 13D.

Moreover, though not shown in the figures, in the fourth embodiment, the controller 20 controls energization of the multi-phase coil 11a as described in the first embodiment. Consequently, magnetic circuits φ1, φ2 and φ3 are formed in the rotating electric machine 10D as shown in FIGS. 4 and 5; rotating magnetomotive force Fr is generated as shown in FIG. 6; and torque F is produced as indicted by the characteristic line F1 in FIG. 7.

According to the fourth embodiment, it is possible to achieve the same advantageous effects as described in the first to the third embodiments.

Moreover, in the fourth embodiment, in the second radial gap G2, there are provided the under-pole permanent magnets 13m4 so that each of the under-pole permanent magnets 13m4 is radially aligned with a corresponding one of the magnetic pole portions 13a and located on the opposite radial side of the corresponding magnetic pole portion 13a to the armature 11.

With the above configuration, it is possible to produce additional magnet torque by the under-pole permanent magnets 13m4. Consequently, it is possible to secure a large magnetomotive force even when the three-phase electric current supplied to the multi-phase coil 11a is reduced.

### Other Embodiments

While the above particular embodiments have been shown and described, it will be understood by those skilled in the art that the present invention can also be embodied in various other modes without departing from the spirit of the present invention.

For example, in the third and fourth embodiments, the magnetic pole portions 13a and the bypass yoke portion 13c are fixed together (or mechanically connected into one piece) by the bridge portions 13d that radially extend to bridge (or mechanically connect) the magnetic pole portions 13a and the bypass yoke portion 13c (see FIGS. 10-11).

However, the magnetic pole portions 13a and the bypass yoke portion 13c may be fixed together by fixing members instead of the bridge portions 13d.

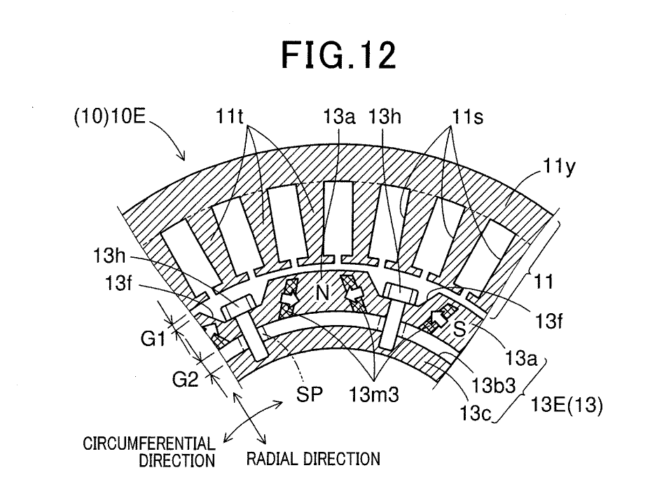

The fixing members may be formed, preferably, of a nonmagnetic material. For example, a modification of the rotating electric machine 10C according to the third embodiment is shown in FIG. 12. In this modification, the magnetic pole portions 13a and the bypass yoke portion 13c are fixed together by a plurality of screws 13h (i.e., fixing members) instead of the bridge portions 13d shown in FIG. 10. Moreover, as indicated by two-dot chain lines in FIG. 12, a plurality of spacers SP are radially interposed between the magnetic pole portions 13a and the bypass yoke portion 13c. Consequently, with the spacers SP, it is possible to maintain the second radial gap G2 and prevent displacement of the magnetic pole portions 13a and the bypass yoke portion 13c. Similarly, though not graphically shown, in the rotating electric machine 10D according to the fourth embodiment, the magnetic pole portions 13a and the bypass yoke portion 13c may be fixed together by a plurality of screws 13h instead of the bridge portions 13d shown in FIG. 11. In addition, the fixing members are not limited to the screws 13h, but may be alternatively implemented by bolts or fixing pins. With the fixing members, it is possible to achieve the same advantageous effects as with the bridge portions 13d.

In the first to the fourth embodiments, the bypass yoke portion 13c is formed separately from and assembled to the rotating shaft 15 (see FIG. 1). However, in the case where at least part of the rotating shaft 15 is formed of a soft-magnetic material, the bypass yoke portion 13c may be implemented by a part of the rotating shaft 15 which is formed of the soft-magnetic material. In other words, the bypass yoke portion 13c may be formed as a part of the rotating shaft 15. In this case, it is also possible to achieve the same advantageous effects as described in the first to the fourth embodiments.

In the first to the fourth embodiments, the multi-phase coil 11a is configured as a three-phase coil (see FIG. 3). However, the number of phases of the multi-phase coil 11a may be greater than 3.

In the first to the fourth embodiments, the U-phase, V-phase and W-phase windings 11U, 11V and 11W of the multi-phase coil 11a are connected together to form a Y-connection (see FIG. 3). However, the U-phase, V-phase and W-phase windings 11U, 11V and 11W of the multi-phase coil 11a may be connected together to form a Δ connection or a Y-A connection.

In the first to the fourth embodiments, the present invention is applied to the inner rotor-type rotating electric machines 10A-10D. However, the present invention may also be applied to outer rotor-type rotating electric machines where a rotor 13 is rotatably disposed radially outside an armature 11.

What is claimed is:

1. A rotating electric machine comprising:
an armature including an armature core and a multi-phase coil, the armature core having a plurality of slots formed therein, the multi-phase coil being wound on the armature core so as to be received in the slots of the armature core;
a rotor disposed so as to radially face the armature through a first radial gap formed therebetween; and
a controller that controls energization of the multi-phase coil,
wherein
the rotor includes a plurality of magnetic pole portions, a plurality of inter-pole permanent magnets and a bypass yoke portion,
the magnetic pole portions are spaced from one another in a circumferential direction of the rotor,
each of the inter-pole permanent magnets is interposed between one circumferentially-adjacent pair of the magnetic pole portions,
the bypass yoke portion is located on an opposite radial side of the magnetic pole portions and the inter-pole permanent magnets to the armature,
between the bypass yoke portion and the magnetic pole portions and the inter-pole permanent magnets, there is formed a second radial gap,
the number of the magnetic pole portions is equal to the number of magnetic poles to be created in the armature core upon energization of the multi-phase coil,
the inter-pole permanent magnets are circumferentially magnetized and arranged such that for each circumferentially-adjacent pair of the inter-pole permanent magnets, the magnetization directions of the two inter-pole permanent magnets of the pair are opposite to each other, and
a plurality of magnetic circuits are formed by the armature core, the magnetic pole portions, the inter-pole permanent magnets and the bypass yoke portion, each of the magnetic circuits passing through one circumferentially-adjacent pair of the magnetic pole portions.

2. The rotating electric machine as set forth in claim 1, wherein the rotor further includes a magnetic reluctance portion that is provided in the second radial gap so as to rotate together with the magnetic pole portions and the bypass yoke portion, the magnetic reluctance portion being magnetically resistant to the magnetic pole portions.

3. The rotating electric machine as set forth in claim 1, wherein the magnetic pole portions and the bypass yoke portion are mechanically connected into one piece either by a plurality of bridge portions of the rotor radially extending to bridge the magnetic pole portions and the bypass yoke portion or by a plurality of fixing members that fix the magnetic pole portions to the bypass yoke portion.

4. The rotating electric machine as set forth in claim 1, wherein the inter-pole permanent magnets are arranged in pairs so that each pair of the inter-pole permanent magnets forms a truncated V-shape that opens toward the armature side.

5. The rotating electric machine as set forth in claim 4, wherein the rotor has a plurality of recesses each of which is formed in an armature-side peripheral surface of the rotor so as to be located within the truncated V-shape of one pair of the inter-pole permanent magnets.

6. The rotating electric machine as set forth in claim 1, wherein in the second radial gap, there are provided a plurality of under-pole permanent magnets so that each of the under-pole permanent magnets is radially aligned with a corresponding one of the magnetic pole portions and located on an opposite radial side of the corresponding magnetic pole portion to the armature.

7. The rotating electric machine as set forth in claim 1, wherein the controller controls energization of the multi-phase coil to apply magnetomotive force generated in the armature core to the magnetic pole portions of the rotor, and
the controller also controls a phase angle of the magnetomotive force to be not equal to 0° in electrical angle, the phase angle taking a positive value in a rotational direction of the rotor with an intermediate position between one pair of the magnetic pole portions of the rotor being a reference position.

8. The rotating electric machine as set forth in claim 1, wherein the plurality of magnetic circuits include a first magnetic circuit via which magnetic flux flows through the armature core, the circumferentially-adjacent pair of the magnetic pole portions and the bypass yoke portion, and a second magnetic circuit via which magnetic flux flows through the armature core, the circumferentially-adjacent pair of the magnetic pole portions and the inter-pole permanent magnet interposed between the circumferentially-adjacent pair of the magnetic pole portions, and
the controller controls energization of the multi-phase coil to selectively cause the magnetic flux flowing in the first magnetic circuit and the magnetic flux flowing in the second magnetic circuit to flow either in the same direction or respectively in opposite directions at the circumferentially-adjacent pair of the magnetic pole portions.
